(19) United States
(12) Patent Application Publication
(10) Pub. No.: US 2011/0077769 A1
(43) Pub. Date: Mar. 31, 2011

(54) NUMERICAL CONTROL PROGRAMMING METHOD AND ITS DEVICE

(75) Inventors: Susumu Matsubara, Tokyo (JP); Kenji Iriguchi, Tokyo (JP)

(73) Assignee: MITSUBISHI ELECTRIC CORPORATION, Tokyo (JP)

(21) Appl. No.: 12/995,285

(22) PCT Filed: Jun. 11, 2008
(86) PCT No.: PCT/JP2008/060635

§ 371 Date: Nov. 30, 2010

(51) Int. Cl. G05B 19/4097; B23Q 15/00; G06F 19/00

(52) U.S. Cl. 700/118

(57) ABSTRACT

A machining shape is created from a product shape and a material shape so that an appropriate tool direction can be automatically set, with which a finished area is the largest and an uncut amount of a recessed edge is the minimum even if a plurality of machinable tool directions are available. All tool directions capable of face machining from a plane-machined shape extracted from the machining shape are acquired to evaluate an area which can be machined in each tool direction. In addition, a length of the recessed edge which cannot be machined in each tool direction is evaluated. A machining program for machining is created from the tool direction where the machinable area is the maximum and the length of the recessed edge which cannot be machined is the minimum.

### TECHNICAL FIELD

The present invention relates to a numerical control programming method and its device which automatically generate a machining program for numerical control.

### BACKGROUND ART

Hitherto, there has been proposed a process design support system which includes a removal area extraction unit for extracting a machining removal area from material and product shape data, a minimum division unit which divides the machining removal area and gathers minimum removal areas, a removal area reconstitution unit which reconstitutes the machining removal area as a gathering of machining primitives combined with the minimum division areas to form a plurality of types of machining reconstitution removal areas, a machining order decision unit for deciding machining orders in each machining primitive, a machining feature recognition unit for allocating a machining feature to each machining primitive to make the machining process a machining process candidate, and a machining process evaluation unit for evaluating each machining process candidate to select an optimal machining process (for example, see Japanese Patent Unexamined Publication No. 2005-309713-A).

Patent Citation 1: Unexamined Published Japanese Patent Application No. 2005-309713-A

### DISCLOSURE OF THE INVENTION

Problems that the Invention is to Solve

Since the process design support system of the related art is configured as described above, a plurality of machining processes is proposed, and a worker can select the processes, but there was a problem in that the machining processes cannot be automatically selected.

The present invention has been made in order to solve the above-mentioned problem and an object of the present invention is to obtain a numerical control program and a device thereof which, even if there is a plurality of machinable tool directions, can automatically set a suitable tool direction with a maximum finished area and a minimum uncut residue amount of the recessed edge, thereby generating a suitable machining program to carry out suitable machining.

### Means for Solving the Problems

A numerical control programming method according to the present invention includes a product shape input step of inputting a solid model of a product shape; a product shape arrangement step of arranging the product shape; a material shape input step of inputting a solid model of a material shape; a material shape arrangement step of arranging the material shape; a machining shape creation step of carrying out a differential calculation of the solid model of the material shape and the solid model of the product shape, thereby creating a solid model of the machining shape; a step of setting a tool direction with a large finished area from the solid model of the machining shape to be a tool direction; a step of extracting the solid model of the machining shape and the solid model of the machining shape which can be machined by the set tool direction; a line and face machining data creation step of creating line machining data including a solid model of a line machining shape and a line machining method and face machining data including a solid model of a face machining shape and a face machining method using the solid model of the extracted machining shape; and a program creation step of creating a machining program in which a machining order for carrying out the line machining and the face machining is described, based on the line and face machining data.

In the numerical control programming method according to the present invention, the step of setting the tool direction with the large finished area from the solid model of the machining shape to be the tool direction obtains the overall tool direction in which the face machining is possible from a face machining shape extracted from the solid model of the machining shape, and sets the tool direction with a maximum finished area as the tool direction.

The numerical control programming method according to the present invention includes a step of setting a tool direction with a minimum uncut residue amount as a tool direction when the tool direction is set in the machining shape.

A numerical control programming device according to the present invention includes a product shape input unit for inputting a solid model of a product shape; a product shape arrangement unit for arranging the product shape; a material shape input unit for inputting a solid model of a material shape; a material shape arrangement unit for arranging the material shape; a machining shape creation unit for carrying out a differential calculation of the solid model of the material shape and the solid model of the material shape to create a solid model of the machining shape; a line and face machining data creation unit which sets a tool direction with a large finished area from the solid model of the machining shape created by the machining shape creation unit to be a tool direction, extracts the solid model of the machining shape created by the machining shape creation unit and the solid model of the machining shape which can be machined by the set tool direction, and creates line machining data including a solid model of a line machining shape and a line machining method and face machining data including a solid model of a face machining shape and a face machining method by the solid model of the extracted machining shape, and a program creation unit for creating a machining program in which a machining order for carrying out the line machining and the face machining is described, based on the line and face machining data.

In the numerical control programming device according to the present invention, the line and face machining data creation unit acquires the overall tool direction in which the face machining is possible from the face machining shape extracted from the solid model of the machining shape, and sets the tool direction with a maximum finished area as the tool direction.

In the numerical control programming device according to the present invention, the line and face machining data creation unit sets a tool direction with a minimum uncut residue amount as a tool direction when the tool direction is set in the machining shape.

### Advantage of the Invention

According to the present invention, even if there is a plurality of machinable tool directions, it is possible to automatically set a suitable tool direction with a maximum finished area and a minimum uncut residue amount of the recessed edge, thereby generating a suitable machining program to carry out a suitable machining.

### BRIEF DESCRIPTION OF THE DRAWINGS

FIG. 1 is a diagram showing a CAD/CAM system to which a numerical control programming device according to the present invention is applied.

FIG. 2 is a diagram showing an example of a shape which is machined by a machining program created by a numerical control programming device according to the present invention.

FIG. 3 is a diagram showing a configuration example of a machining unit which is a constituent of a machining program created by the numerical control programming device according to the present invention.

FIG. 4 is a diagram showing an example of a machining unit which is a constituent of a machining program created by a numerical control programming device according to the present invention.

FIG. 5 is a block diagram showing a configuration of a numerical control programming device according to a first embodiment of the present invention.

FIG. 6 is a diagram showing an example of a product shape machined by a machining program created by a numerical control programming device according to the first embodiment of the present invention.

FIG. 7 is a flow chart for illustrating an operation of a material shape input unit of a numerical control programming device according to the first embodiment of the present invention.

FIG. 8 is a diagram for supplementarily illustrating an operation of a material shape input unit of the numerical control programming device according to the first embodiment of the present invention.

FIG. 9 is a perspective view showing a relationship between a product shape and a material shape machined by the machining program created by the numerical control programming device according to the first embodiment of the present invention.

FIG. 10 is a diagram showing an example of a material attachment tool shape and the size of a machine for machining a material.

FIG. 11 is a diagram showing an example of a relationship of a first attachment tool shape and a second attachment tool shape and a material shape of a machine for machining a material.

FIG. 12 is a diagram which shows a machining shape for illustrating an operation of a machining shape creation unit of the numerical control programming device according to the first embodiment of the present invention.

FIG. 13 is a flow chart for illustrating an operation of an end surface machining data creation unit of the numerical control programming device according to the first embodiment of the present invention.

FIG. 14 is a diagram which shows a shape for supplementarily illustrating the operation of the end surface machining data creation unit of the numerical control programming device according to the first embodiment of the present invention.

FIG. 15 is a flow chart for illustrating an operation of a line and face machining data creation unit of the numerical control programming device according to the first embodiment of the present invention.

FIG. 16 is a diagram which shows the line and face machining shape for supplementarily illustrating the operation of the line and face machining data creation unit of the numerical control programming device according to the first embodiment of the present invention.

FIG. 17 is a flow chart showing processing of deciding a tool direction of the line and face machining data creation unit of the numerical control programming device according to the first embodiment of the present invention.

FIG. 18 is a diagram which shows a shape for supplementarily illustrating the operation of the line and face machining data creation unit of the numerical control programming device according to the first embodiment of the present invention.

FIG. 19 is a diagram showing a vector arrangement evaluated from a target shape of FIG. 18.

FIG. 20 is a diagram which shows a shape for supplementarily illustrating the operation of the line and face machining data creation unit of the numerical control programming device according to the first embodiment of the present invention.

FIG. 21 a diagram for supplementarily illustrating the operation of the line and face machining data creation unit of the numerical control programming device according to the first embodiment of the present invention.

FIG. 22 is a flow chart which shows processing of a shape division of the line and face machining data creation unit of the numerical control programming device according to the first embodiment of the present invention.

FIG. 23 is a diagram for illustrating a line machining unit of the numerical control programming device according to the first embodiment of the present invention.

FIG. 24 is a diagram for illustrating a face machining unit of the numerical control programming device according to the first embodiment of the present invention.

FIG. 25 is a flow chart which shows allocation processing of the line machining unit and the face machining unit of the line and face machining data creation unit of the numerical control programming device according to the first embodiment of the present invention.

FIG. 26 is a flow chart which shows allocation processing of the line machining unit and the face machining unit of the line and face machining data creation unit of the numerical control programming device according to the first embodiment of the present invention.

FIG. 27 is a diagram for illustrating a shape which is machined by the machining program created by the numerical control programming device according to the first embodiment of the present invention.

### DESCRIPTION OF REFERENCE NUMERALS AND SIGNS

102: Numerical Control Programming Device
205: Product Shape Input Unit
206: Product Shape Arrangement Unit
208: Material Shape Input Unit
210: Material Shape Arrangement Unit
218: Machining Shape Creation Unit
221: Line and Face Machining Data Creation Unit
224: Machining Program Creation Unit

### BEST MODE FOR CARRYING OUT THE INVENTION

### First Embodiment

Hereinafter, a first embodiment of the present invention will be described using the drawings.

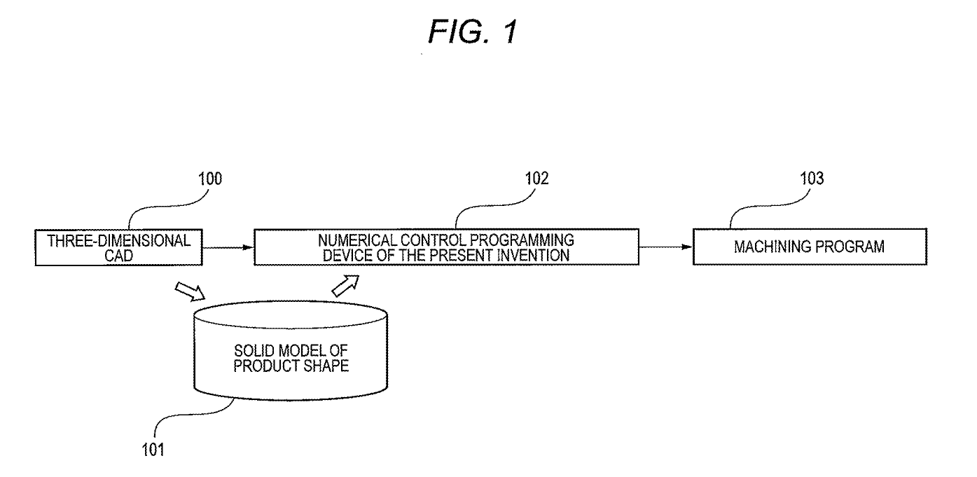

FIG. 1 is a diagram showing a CAD/CAM system to which a numerical control programming device according to a first embodiment of the present invention is applied. In FIG. 1, 100 is a three-dimensional CAD which designs components to create a solid model or the like of a product shape or a material shape, 101 is a solid model of the product shape or the material shape created by three dimensional CAD 100, 102 is a numerical control programming device which creates the numerical control machining program (hereinafter, called a machining program) based on the solid model of the product shape or the material shape and is a target of the present invention, and 103 is a machining program created by the numerical control programming device 102.

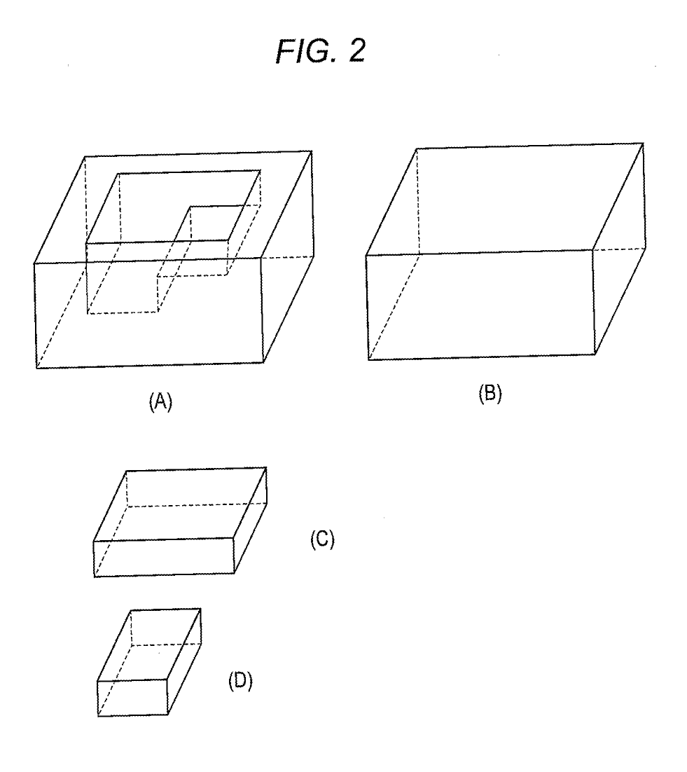

When, for example, a product shape is in the shape as shown in FIG. 2A and a material shape is in the shape as shown in FIG. 2B, the numerical control programming device 102 creates the machining program 103 for carrying out a face machining of a shape as shown in FIG. 2C and a face machining of a shape as shown in FIG. 2D.

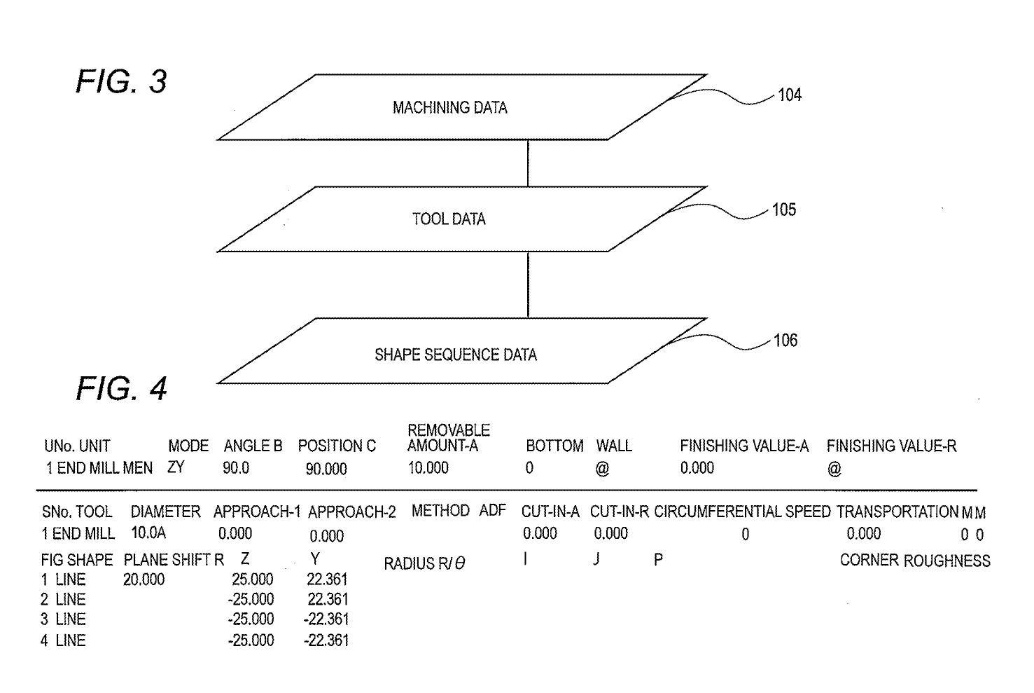

FIG. 3 is a configuration example showing a machining unit which is a constituent of the machining program 103 in a numerical control program 102, a machining data 104 is information of a machining method, a tool data 105 is information of a tool being used and a machining condition, and a shape sequence data 106 of a configuration of a single shape is shape information which defines a shape to be machined.

FIG. 4 is an example (an example which displays the machining unit on a screen) of a machining unit of the machining program 103 in numerical control programming device 102, a program portion indicated by “UNo.” is the machining data 104, a program portion indicated by “SNo.” is the tool data 105, a program portion indicated by “FIG” is the shape sequence data 106.

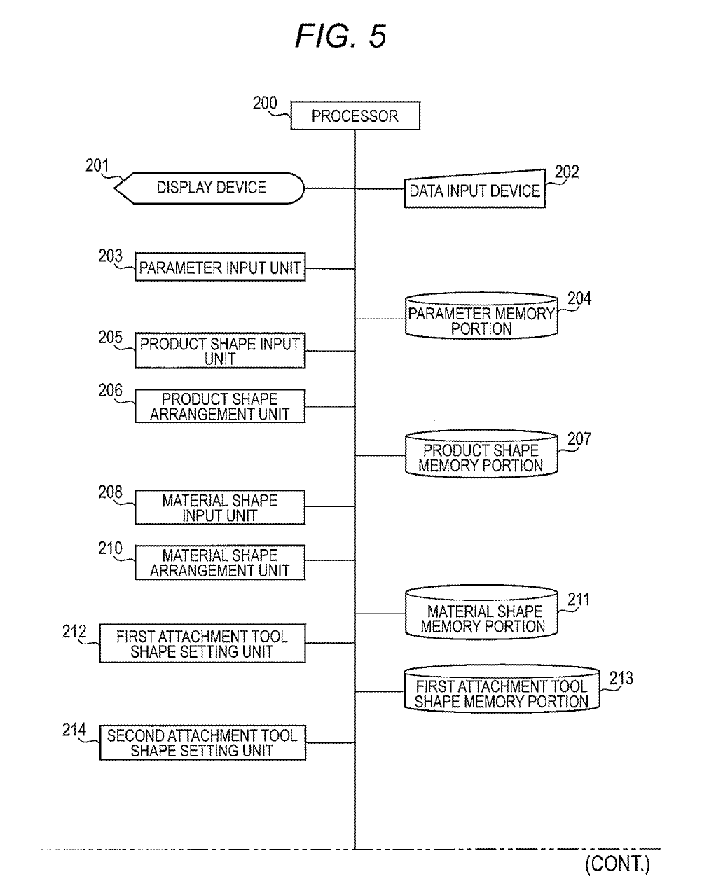

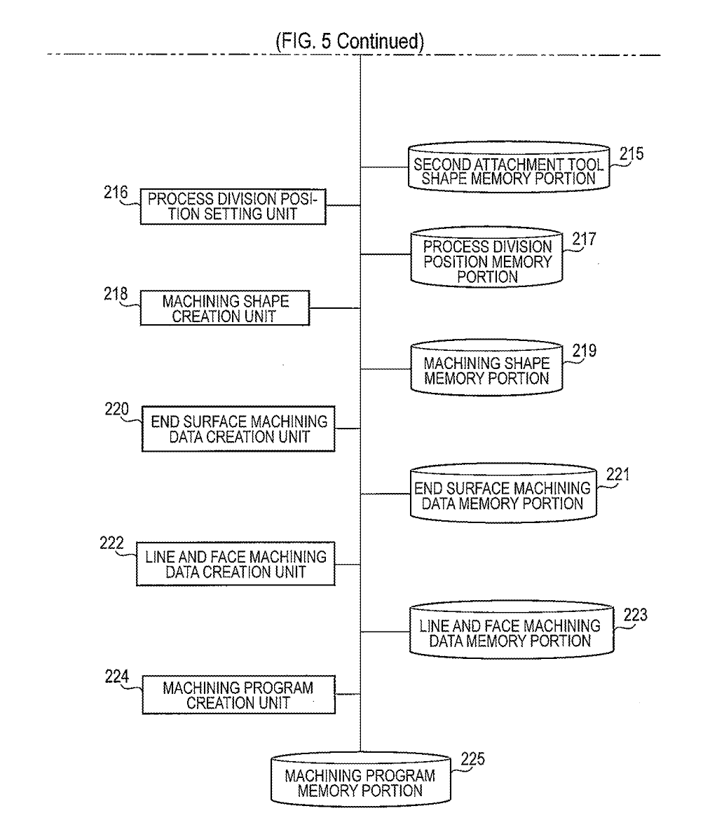

FIG. 5 is a configuration diagram showing the numerical control programming device 102 according to the first embodiment of the present invention. In FIG. 5, 200 is a processor for performing an overall control of the numerical control programming device. 202 is a data input device which receives, for example, an input or the like of a value set by a worker, and 201 is a display device which displays various data or machining program or the like.

203 is a unit for inputting a parameter used when creating the machining data, and 204 is a parameter memory portion for memorizing the input parameter.

205 is a product shape input unit by which the worker inputs a solid model of a product shape created by three dimensional CAD 100, 206 is a product shape arrangement unit which arranges the solid model of the input product shape on program coordinates, and 207 is a product shape memory portion which memorizes the solid model of the product shape arranged on the program coordinates.

208 is a material shape input unit which includes a function in which the worker inputs the solid model of the material shape created by three dimensional CAD 100 and a function of creating the material shape based on the solid model of the product shape memorized in the product shape memory portion 205. 210 is a material shape arrangement unit which arranges the solid model of the material shape on the program coordinates. 211 is a material shape memory portion which memorizes the solid model of the material shape arranged on the program coordinates. Material shape input unit 208 may include any one of a function in which the worker inputs the solid model of the material shape created by the three dimensional CAD 100 and a function of creating the material shape based on the solid model of the product shape memorized in the product shape memory portion 205.

212 is a first attachment tool shape setting unit in which the worker sets a solid model of first attachment tool shape for grasping the material shape when performing the machining in a first process. 213 is a first attachment tool shape memory portion which memorizes the solid model of the set first attachment tool shape. 214 is a second attachment tool shape setting unit in which the worker sets a solid model of second attachment tool shape for grasping the material shape when performing the machining in a second process. 215 is a second attachment tool shape memory portion which memorizes the solid model of the set second attachment tool shape. 216 is a process division position setting unit in which the worker sets division positions of initially machined first process and the next machined second process. 217 is a process division memory portion which memorizes the set process division positions.

218 is a machining shape creation unit which creates the solid model of the machining shape from the solid model of the product shape memorized in the product shape memory portion 207 and the solid model of the material shape memorized by the material shape memory portion 211. 219 is a machining shape memory portion which memorizes the solid model of the created machining shape.

220 is an end surface machining data creation unit which creates end surface machining data including the solid model of the end surface machining shape and an end surface machining method, based on the solid model of the product shape memorized in the product shape memory portion 207, the solid model of the machining shape memorized in the machining shape memory portion 219, the solid model of the first attachment tool shape memorized in the first attachment tool shape memory portion 213, the solid model of the second attachment tool shape memorized in the second attachment tool shape memory portion 215, and the process division positions memorized by the process division position memory portion 217. 221 is an end surface machining data memory portion which memorizes the created end surface machining data.

222 is a line and face machining data creation unit which creates line machining data including a solid model of a line machining shape and a line machining method and face machining data including a solid model of a face machining shape and a face machining method, based on the solid model of the product shape memorized in the product shape memory portion 207, the solid model of the machining shape memorized in the machining shape memory portion 219, the end surface machining data memorized in the end surface machining data memory portion 221, the solid model of the first attachment tool shape memorized in the first attachment tool shape memory portion 213, the solid model of the second attachment tool shape memorized in the second attachment tool shape memory portion 215, and the process division positions memorized by the process division position memory portion 217. 223 is a line and face machining data memory portion which memorizes the created line machining data and face machining data.

224 is a machining program creation unit which creates machining program based on the end surface machining data memorized in the end surface machining data memory portion 221 and the line and face machining data memorized in line and face machining data memory portion 223. 225 is a machining program memory portion which memorizes the created machining program.

Hereinafter, the solid model of the product shape is called a product shape, the solid model of the material shape is called a material shape, the solid model of the first attachment tool shape is called a first attachment tool shape, the solid model of the second attachment tool shape is called a second attachment tool shape, and the solid model of the machining shape is called a machining shape.

Next, an operation of the device will be described.

First of all, a worker operates the parameter input unit 203 to set parameters which are necessary when creating the machining data. As the parameters, for example, an end surface cut-off amount, a line machining radial direction maximum removable amount, a line machining axial direction maximum removable amount, a face mill protrusion amount, an end mill protrusion amount, a tool diameter when a recessed pin angle exists, a line machining maximum tool diameter or the like are set. The set parameters are memorized in the parameter memory portion 204.

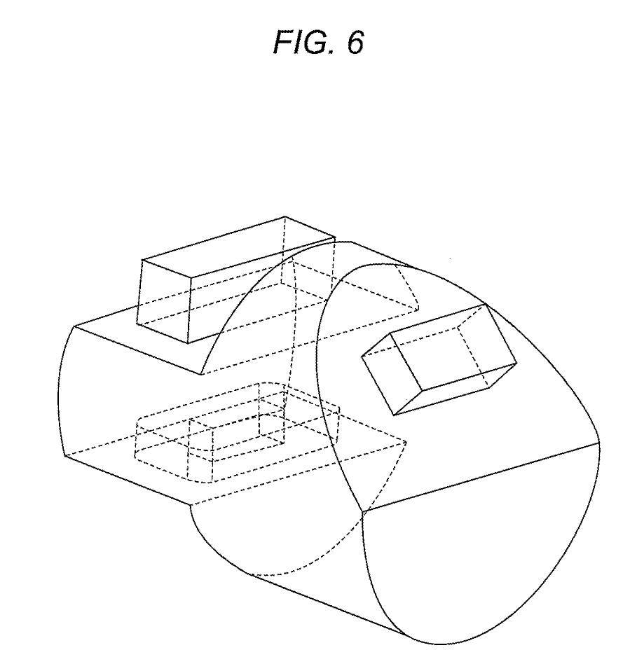

Next, the worker operates the product shape input unit 205 to input the product shape, for example, shown in FIG. 6 created by the three dimensional CAD 100.

Next, a middle position of a X axis direction, a middle position of a Y axis direction, and a middle position of a Z axis direction of the product shape are evaluated from a X axis length, Y axis length and Z axis length by the product shape arrangement unit 206, thereby setting X coordinate values of the middle position of the X axis direction, Y coordinate values of the middle position of the Y axis direction, and Z coordinate values of the middle position of the Z axis direction as X coordinate values, Y coordinate values and Z coordinate values of the center position coordinates of the product shape. The product shape is subjected to parallel translation so that the center position coordinate of the product shape is situated on the Z axis. By parallel translating the product shape so that a −Z axis direction end surface of the product shape is Z=0.0, the product shape is arranged on programming coordinates, thereby memorizing the product shape arranged on the programming coordinates in the product shape memory portion 207.

Herein, the X axis length, the Y axis length and the Z axis length of the product shape are evaluated by geometrically analyzing the product shape.

Next, the worker operates the material shape input unit 208 to input the material shape created by the three dimensional CAD 100. The middle position of the X axis direction, the middle position of the Y axis direction, and the middle position of the Z axis direction of the product shape are evaluated from the X axis length, the Y axis length and the Z axis length of the material shape by the material shape arrangement unit 210, thereby setting X coordinate values of the middle position of the X axis direction, Y coordinate values of the middle position of the Y axis direction, and Z coordinate values of the middle position of the Z axis direction as X coordinate values, Y coordinate values and Z coordinate values of the center position coordinates of the material shape. The material shape is subjected to parallel translation so that the center position coordinates of the material shape coincide with the center position coordinates of the product shape situated on the programming coordinates which are memorized in the product shape memory portion 207, thereby memorizing the material shape arranged on the programming coordinates in the material shape memory portion 211.

Herein, the X axis length, the Y axis length and the Z axis length of the material shape are evaluated by geometrically analyzing the product shape.

However, in a case where the material shape is not created by the three dimensional CAD 100, the material shape input unit 208 creates the material shape, so that the created material shape is subject to parallel translation to the programming coordinates by the material shape arrangement unit 210, thereby memorizing the material shape in the material shape memory portion 211.

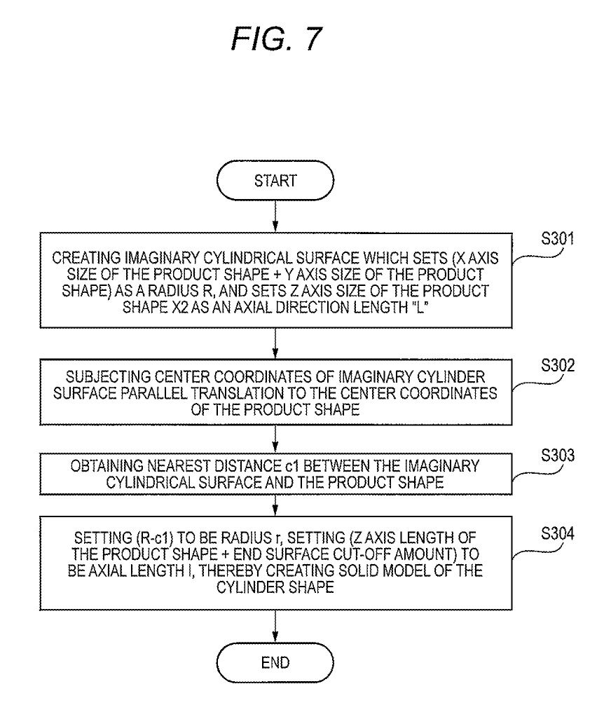

Herein, an operation of the material shape input unit 209 will be described based on the flow chart of FIG. 7.

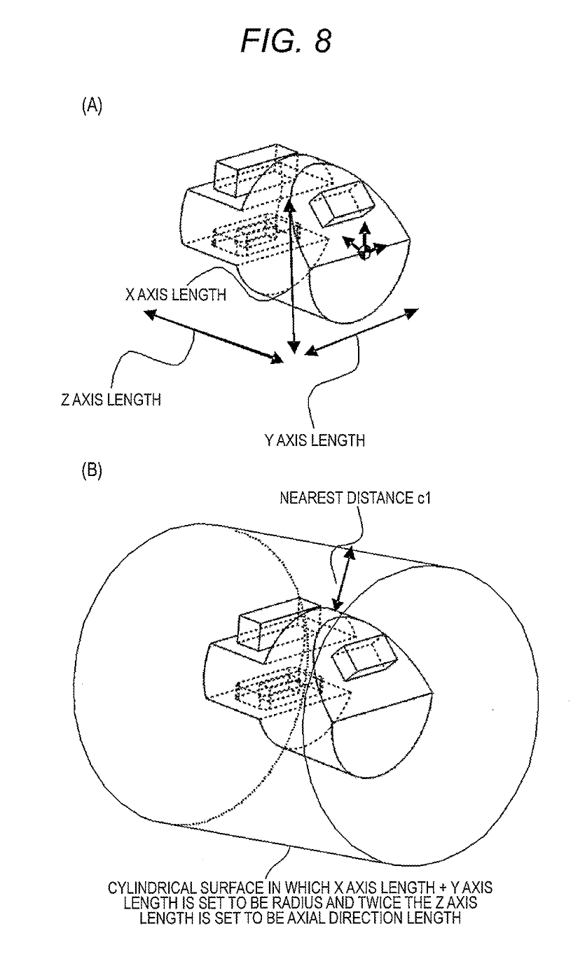

That is, in order to create a cylinder with a sufficient diameter greater than the product shape, as shown in FIG. 8A, an imaginary cylindrical surface is created which sets a value meeting the X axis length of the product shape and the Y axis length of the product shape as a radius R, sets twice the Z axis length of the product shape as an axial direction length, and sets the Z axis as an axis center (step S301).

Next, as shown in FIG. 8B, the product shape is subjected to parallel translation so that the center coordinates of the product shape are set as the center of the cylindrical surface (step S302).

Next, as shown in FIG. 8B, nearest distance cl between an imaginary cylindrical surface and the product shape is evaluated by the geometric analysis (step S303).

Next, a value which subtracts nearest distance c1 from radius R of the imaginary cylinder is set to be radius r, a value which adds the end surface cut-off amount memorized in the parameter memory portion 204 to the Z axis length of the product shape is set to be axial length l, and the solid model of the cylinder shape is created to be a material shape (step S304).

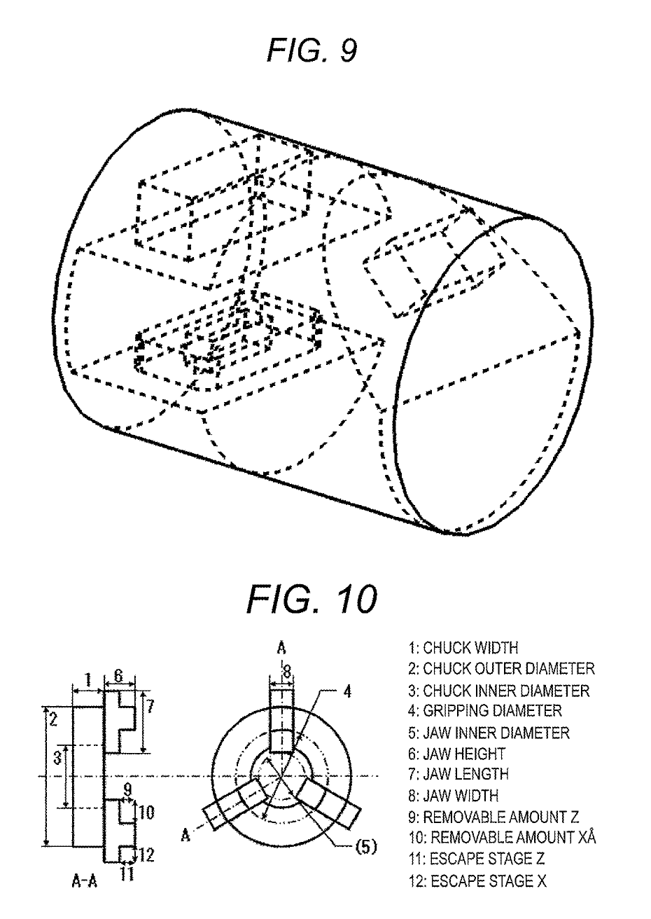

Herein, the middle position of the X axis direction, the middle position of the Y axis direction and the middle position of the Z axis direction of the material shape are evaluated from the X axis length, the Y axis length and the Z axis length of the material shape by material shape arrangement unit 210, thereby setting the X coordinate value of the middle position of the X axis direction, the Y coordinate value of the middle position of the Y axis direction, and the Z coordinate value of the middle position of the Z axis direction as the X coordinate value, the Y coordinate value and the Z coordinate value of the center position coordinates of the product shape. The material shape is subjected to parallel translation so that the center position coordinates of the material shape coincide with the center position coordinates of the product shape arranged on the programming coordinates which are memorized in the product shape memory portion 207, thereby memorizing the material shape arranged on the programming coordinates in the material shape memory portion 211. As a result, as shown in FIG. 9, the material shape (material shape which has the minimum machining amount when the material shape is machined to create the product shape) which is the most suitable for machining the product shape is created.

Next, the worker operates a first attachment tool shape setting unit 212, as shown in FIG. 10, sets each value of a gripping diameter, a jaw number, a jaw inner diameter, a jaw height, a jaw length, a jaw width, removable amount Z, removable amount X, escape stage Z and escape stage X and sets whether the first attachment tool shape is an outer jaw or an inner jaw, and creates the solid model of the first attachment tool shape to memorize the solid model in first attachment tool shape memory portion 213.

Next, the worker operates a second attachment tool shape setting unit 214, sets each value of a gripping diameter, a jaw number, a jaw inner diameter, a jaw height, a jaw length, a jaw width, removable amount Z, removable amount X, escape stage Z and escape stage X and sets whether the second attachment tool shape is an outer jaw or an inner jaw, and creates the solid model of the second attachment tool shape to memorize the solid model in a second attachment tool shape memory portion 215.

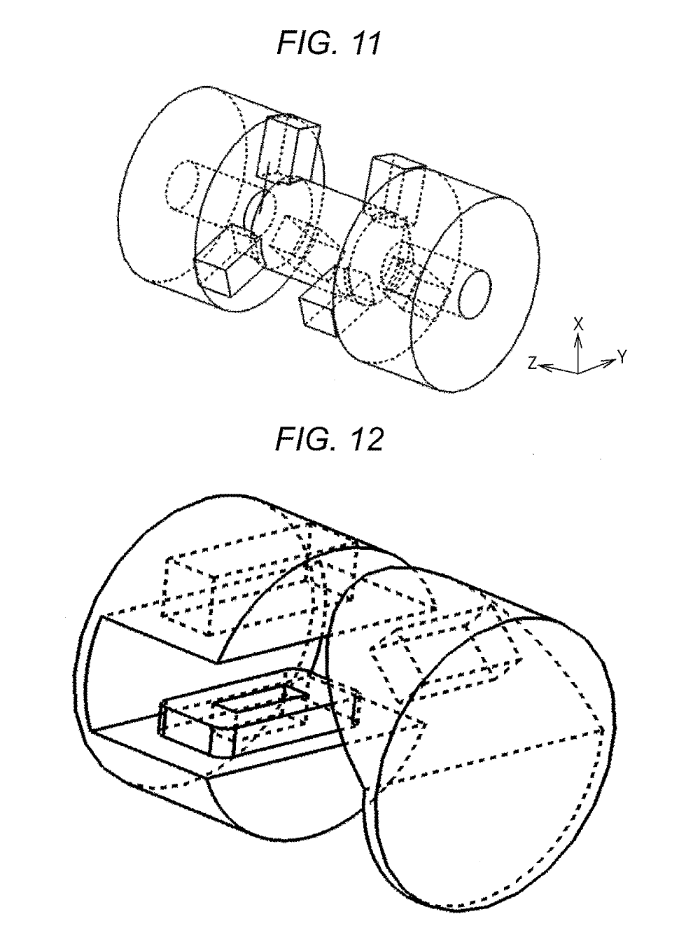

As a result, as shown in FIG. 11, when the material shape is machined to create the product shape, the material shape can be reliably grasped by the first attachment tool and the second attachment tool.

Next, the worker operates a process division position setting unit 216, and sets the Z coordinate values of the process division positions of the first process and the second process and the length in which the first process and the second process are repeatedly machined as an overlap amount, thereby the Z coordinate values of the process division positions and the overlap amount are memorized in process division position memory portion 217.

When the product shape and the material shape are respectively memorized in a product shape memory portion 207 and a material shape memory portion 211, a machining shape creation unit 218 performs a differential calculation which subtracts the product shape from the material shape to create the machining shape as shown in FIG. 12, thereby memorizing the machining shape in a machining shape memory portion 219.

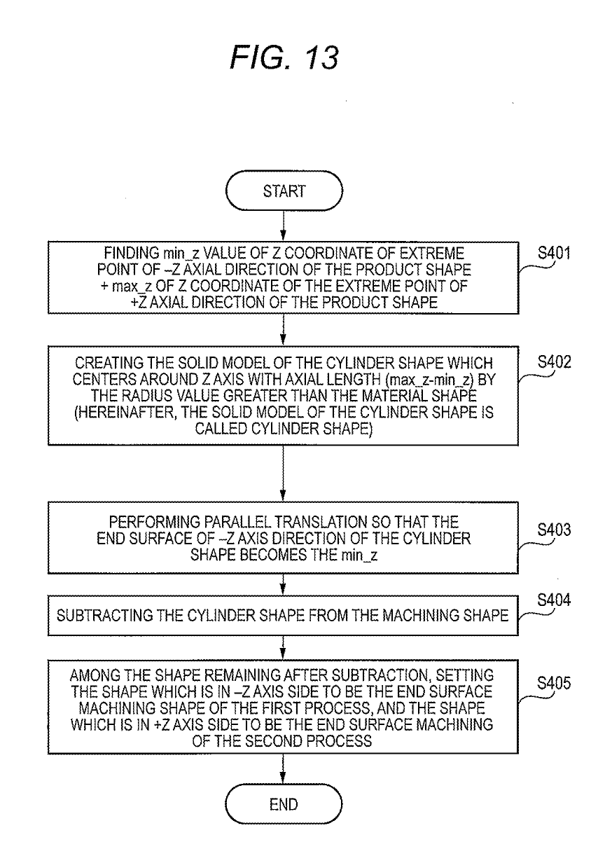

Herein, an operation of end surface machining data creation unit 220 will be described based on the flow chart of FIG. 13.

First of all, an end surface machining data creation unit 220 finds Z coordinate min_z of extreme point of −Z axial direction and Z coordinate max_z of extreme point of +Z axial direction of the product shape (step S410). The extreme point from the product shape with respect to an arbitrary direction is evaluated by geometric analysis.

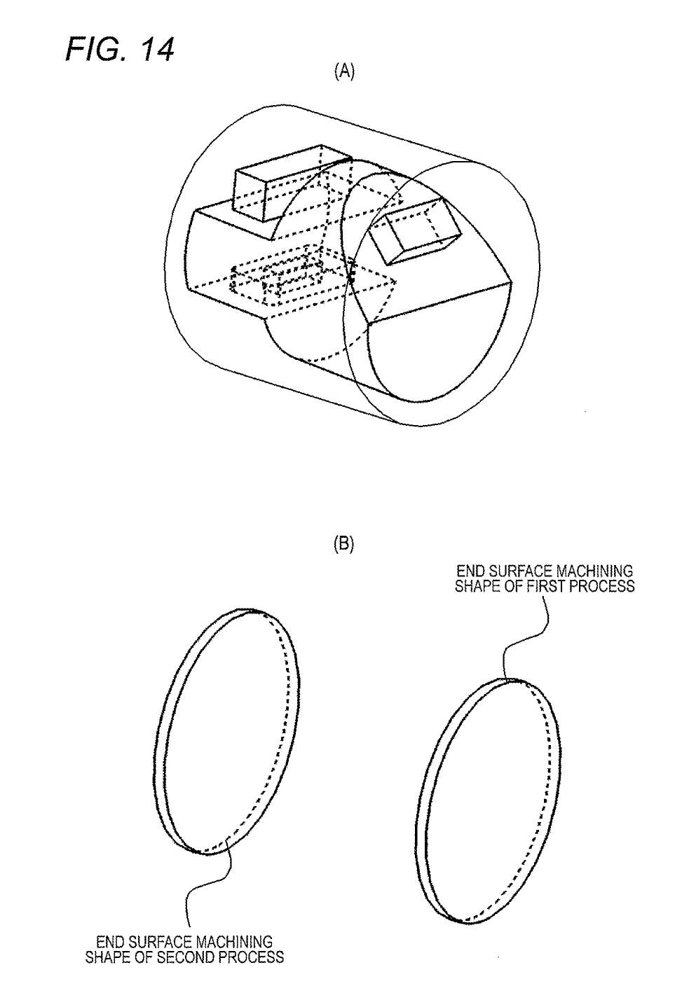

Next, as shown in FIG. 14A, in the same radius value as the material shape or more, the axial direction length creates the solid model of the cylinder shape which sets Z axis as the axis center as described above (max_z-min_z). Hereinafter, the solid model of the cylinder shape is called a cylinder shape (step S402).

Next, the cylinder shape is subjected to parallel translation so that the Z coordinate values of the end surface of −Z axis direction of the cylinder shape become the min_z (step S403).

Next, the cylinder shape is subtracted from the machining shape. This can be evaluated from an assembly calculation of the solid model (step S404).

Next, as shown in FIG. 14B, among the solid models of the shape after subtraction, the solid model of the shape which is on −Z axis side is set to be the solid model of the end surface machining shape of the first process, and the solid model of the shape which is on +Z axis side is set to be the solid model of the end surface machining shape of the second process, thereby memorizing the solid models in the end surface machining data memory portion 221 (step S405). Hereinafter, the solid model of the end surface machining shape is called an end surface shape.

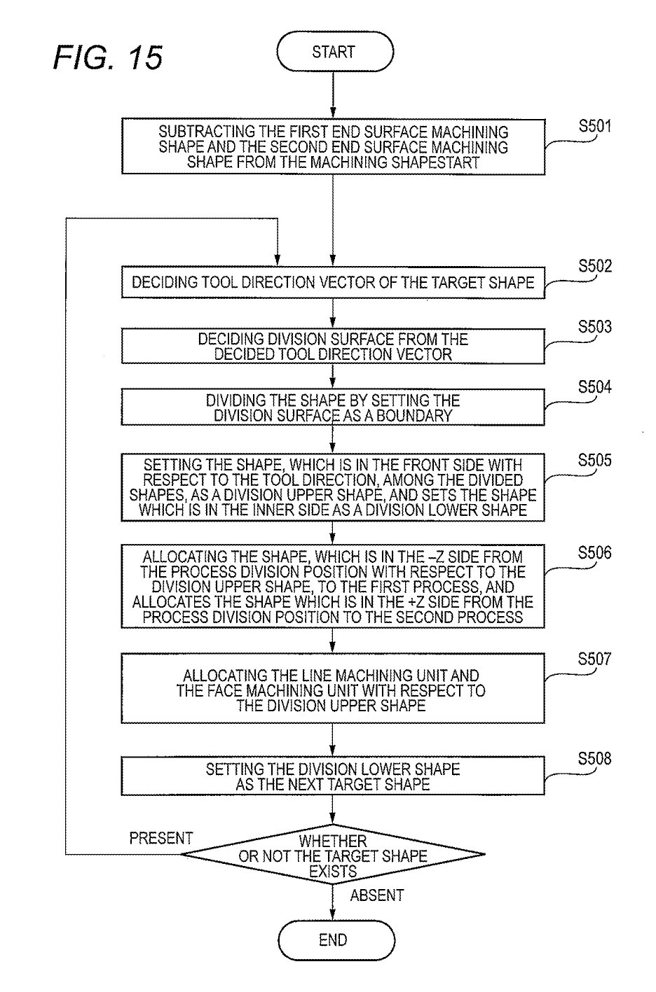

The line and face machining data creation unit 222 creates the line and face machining data for carrying out the line and face machining based on the machining shape memorized in the machining shape memory portion 219 and the end surface machining data memorized in the end surface machining data memory portion 221. FIG. 15 is a flow chart showing processing contents of the line and face machining data creation unit 222. Hereinafter, processing contents of the line and face machining data creation unit 222 will be described in detail with reference to FIG. 15.

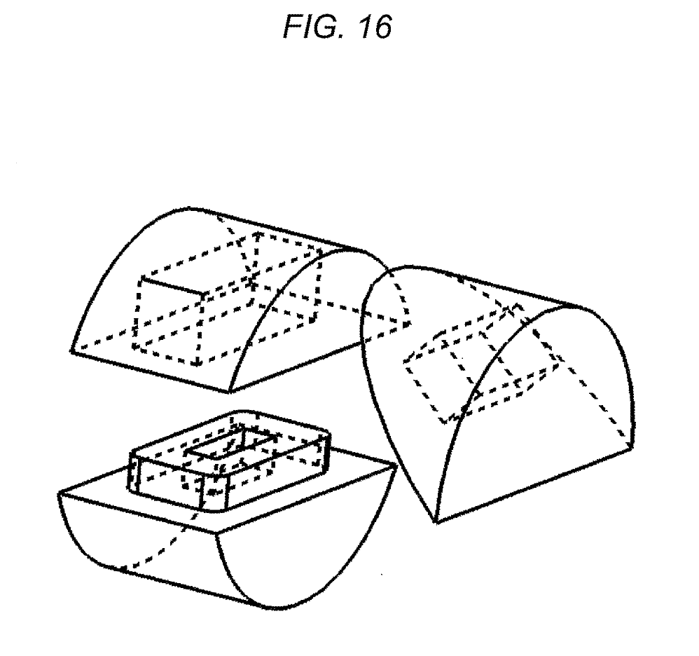

First of all, as shown in FIG. 16, by carrying out the differential calculation which subtracts the end surface machining shape of the end surface data from the machining shape, the line and face machining data creation unit 222 creates the solid model of the line and face machining shape (step S501). Hereinafter, the solid model of the line and face machining shape is called a line and face machining shape.

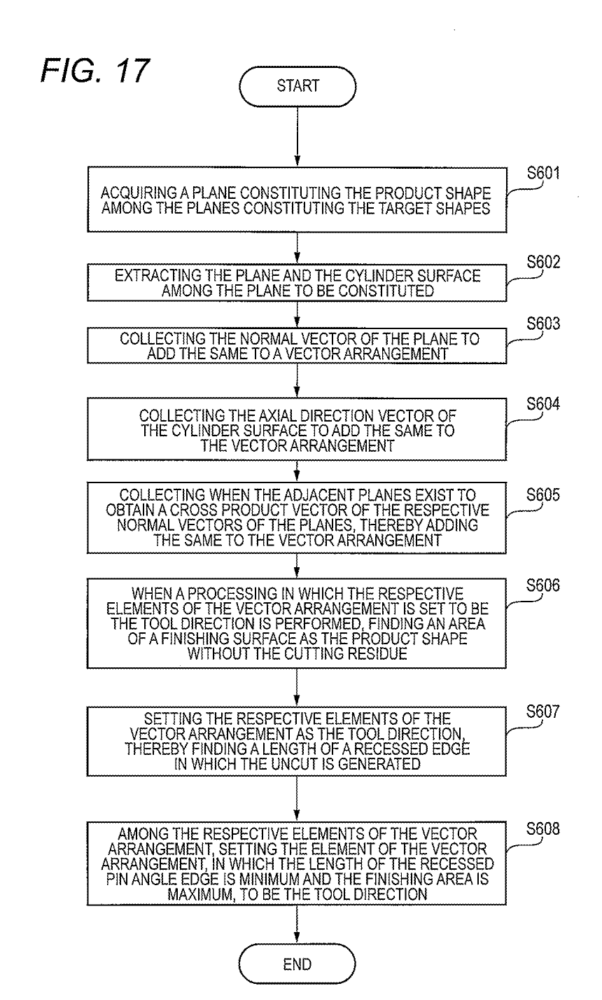

Next, the line and face machining data creation unit 222 sets the shape to be targeted among the line and face machining shapes as the solid model of one target shape, thereby deciding a tool direction vector of the solid model (hereinafter called a target shape) of the target shape (step S502). Details of step S502 will be described later based on FIGS. 17 to 21.

Next, the line and face machining data creation unit 222 collects the plane with the same normal vector as the tool direction vector and sets the foremost plane to be a division surface with respect to the tool direction vector. In a case where plane with the same normal vector as the tool direction vector does not exist, the extreme point coordinate of the target shape relative to the direction of the tool direction vector is evaluated, the extreme point coordinate is set to be a position vector, and the plane which sets the normal vector as the tool direction vector is created and is set to be a division surface (step S503).

The extreme point coordinate relative to the target shape is evaluated by geometric analysis.

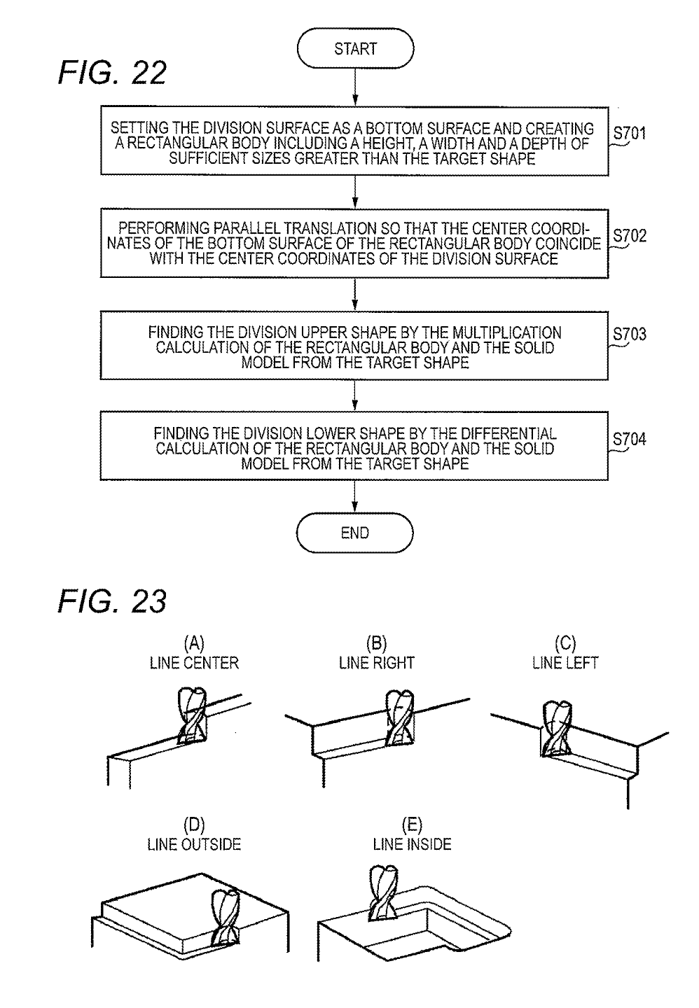

Next, the line and face machining data creation unit 222 divides the shape above and below by setting the division surface as a boundary (step S504). Details of step S504 will be described later based on FIG. 22.

Next, the line and face machining data creation unit 222 sets the shape, which is in the front side with respect to the tool direction, among the divided shapes, as a division upper shape, and sets the shape which is in the inner side as a division lower shape (step S505).

Next, the line and face machining data creation unit 222 allocates the shape, which is in the −Z side from the process division position memorized in the process division position memory portion 217 with respect to the division upper shape, to the first process, and allocates the shape which is on the +Z side from the division process position to the second process (step S506).

Next, the line and face machining data creation unit 222 allocates a suitable unit from the line machining unit and the face machining unit with respect to the division upper shape (step S507). Details of step S507 will be described later based on FIGS. 23 to 25.

Next, line and face machining data creation unit 222 allocates the division lower shape as the next target shape, thereby carrying out the same processing as that of the division upper shape (step S508). It is judged whether or not other target shapes exist, and if target shape does not exist, the processing is finished.

Herein, step 502 will be described in detail. FIG. 17 is a flow chart showing the processing which decides the tool direction of the line and face machining data creation unit 222. Hereinafter, the decision of the tool direction of the line and face machining data creation unit 222 will be described in detail with reference to FIG. 17.

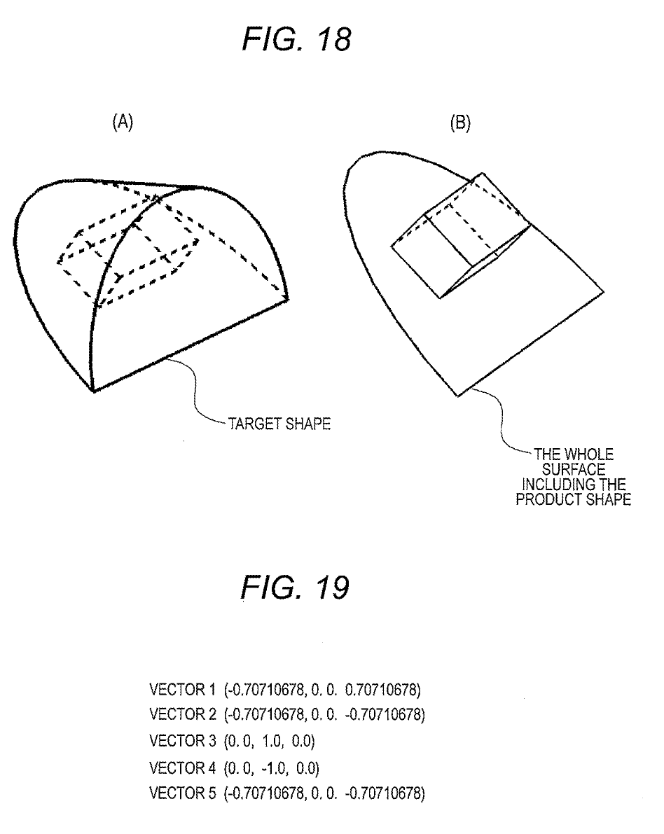

First of all, as shown in FIG. 18, the line and face machining data creation unit 222 acquires a plane constituting the product shape among the planes constituting the target shapes (step S601).

FIG. 18A is a whole plane constituting the target shape and FIG. 18B is a whole plane constituting the product shape.

Next, among the whole plane constituting the product shape, the plane and the cylinder surface are extracted (step S602).

Next, the normal vector of the plane is collected from the extracted plane to add the same to a vector arrangement (step S603). When adding to the vector arrangement, the same vector is not added to the vector arrangement.

Next, the axial direction vector of the cylinder surface is collected from the extracted plane to add the same to the vector arrangement (step S604).

Next, the normal vectors of the adjacent planes are collected from the extracted plane to obtain a cross product vector, thereby adding the same to the vector arrangement (step S605).

FIG. 19 is a vector arrangement evaluated from the target shape of FIG. 18.

Next, when machining in which the element of the vector arrangement is set to be the tool direction is performed, a finished surface is evaluated as the product shape by being machined without the uncut residue, and the area of the whole surface is evaluated and added up (step S606).

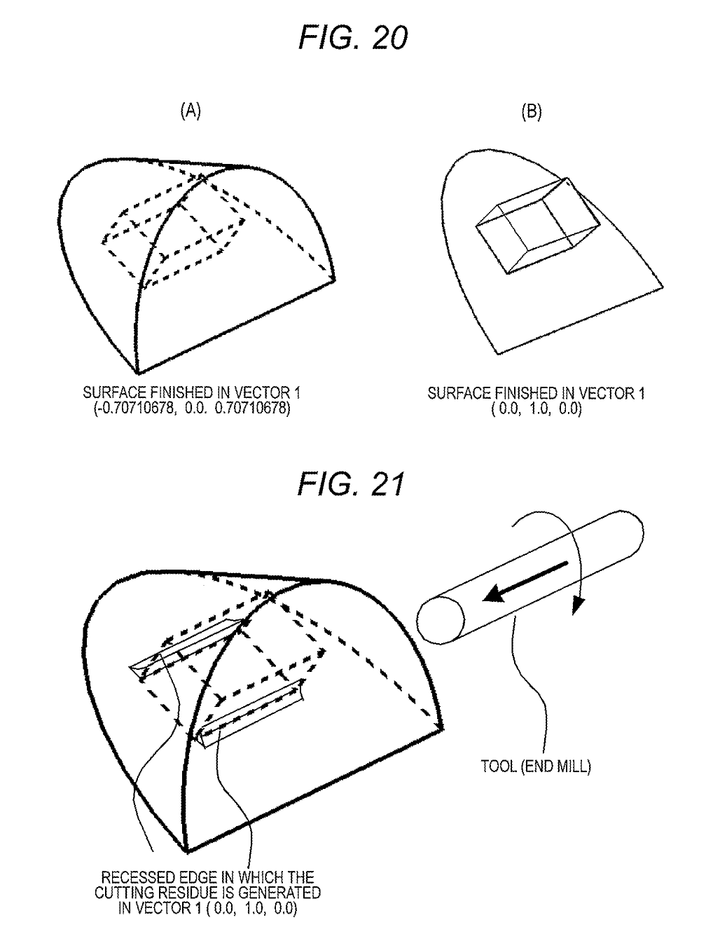

FIG. 20A is a finished surface in vector 1 (−0.70710678, 0.0, 0.70710678), and FIG. 20B is a finished surface in vector 3 (0.0, 1.0, 0.0).

Next, when the end mill machining is performed by setting the element of the vector arrangement as the tool direction, an recessed edge, which is a side where the uncut residue of an inner wall angle of a recessed place is generated, is extracted, thereby obtaining the overall length of the extracted edge (step S607).

FIG. 21 shows an example in which the uncut residue is generated by the recessed edge.

The recessed edge is evaluated by the geometric analysis of the target shape.

Next, among the elements of the vector arrangement, the element of the vector arrangement, in which the length of the recessed edge is minimum and the area of the finished surface is maximum, is set to be the tool direction (step S608).

Herein, step S504 will be described in detail. FIG. 22 is a flow chart showing the processing of the shape division of the line and face machining data creation unit 222. Hereinafter, the shape division of the line and plane data creation unit 222 will be described in detail with reference to FIG. 22.

First of all, the line and plane data creation unit 222 sets the division surface as a bottom surface and creates a rectangular body including a height, a width and a depth of sufficient sizes greater than the target shape (step S701). Since each size of the X axis direction, the Y axis direction and the Z axis direction is evaluated by geometrically analyzing the target shape, the rectangular is created by setting the value which meets all of the respective size values to be a sufficient size larger than the target shape.

Next, the rectangular body is subjected to parallel translation so that the center coordinates of the bottom surface of the rectangular body coincide with the center coordinates of the division surface (step S702).

Next, by the multiplication calculation of the rectangular body and the target shape, the division upper shape is evaluated (step S703).

Next, by the differential calculation of the rectangular body and the target shape, the division lower shape is evaluated (step S704).

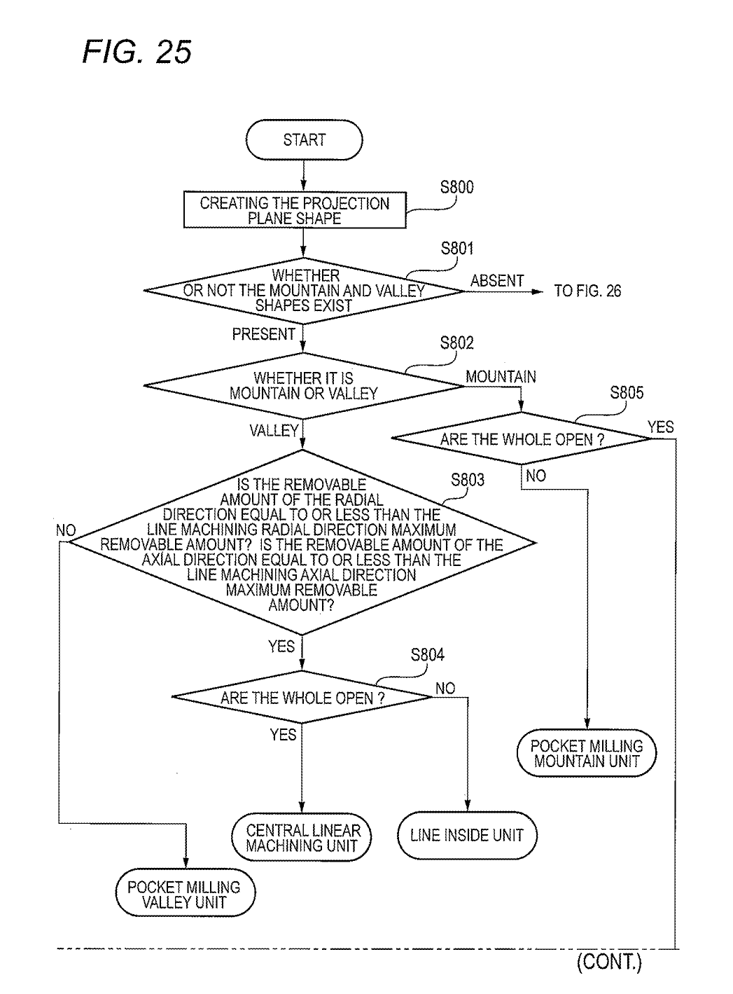

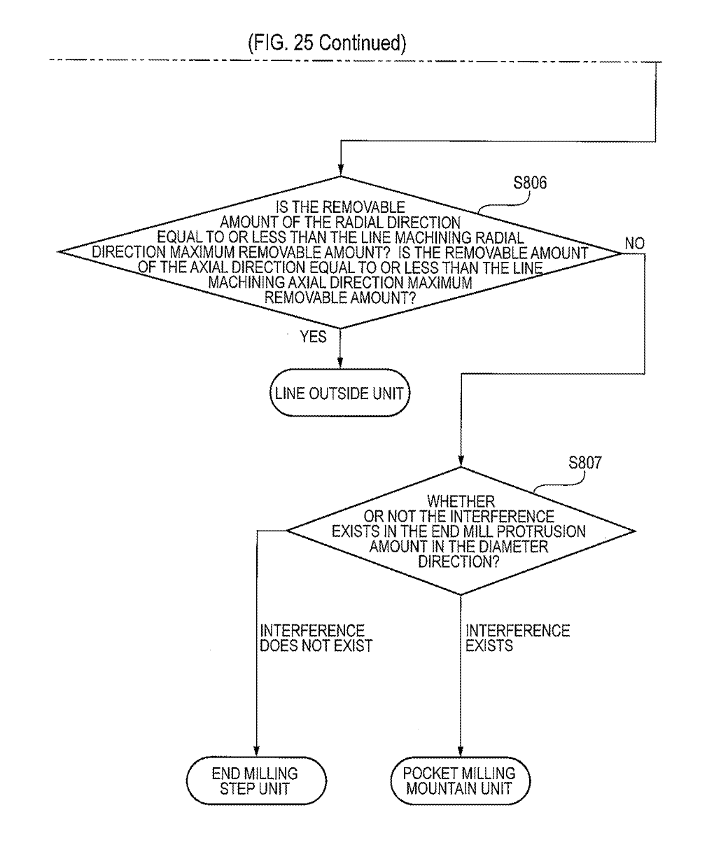

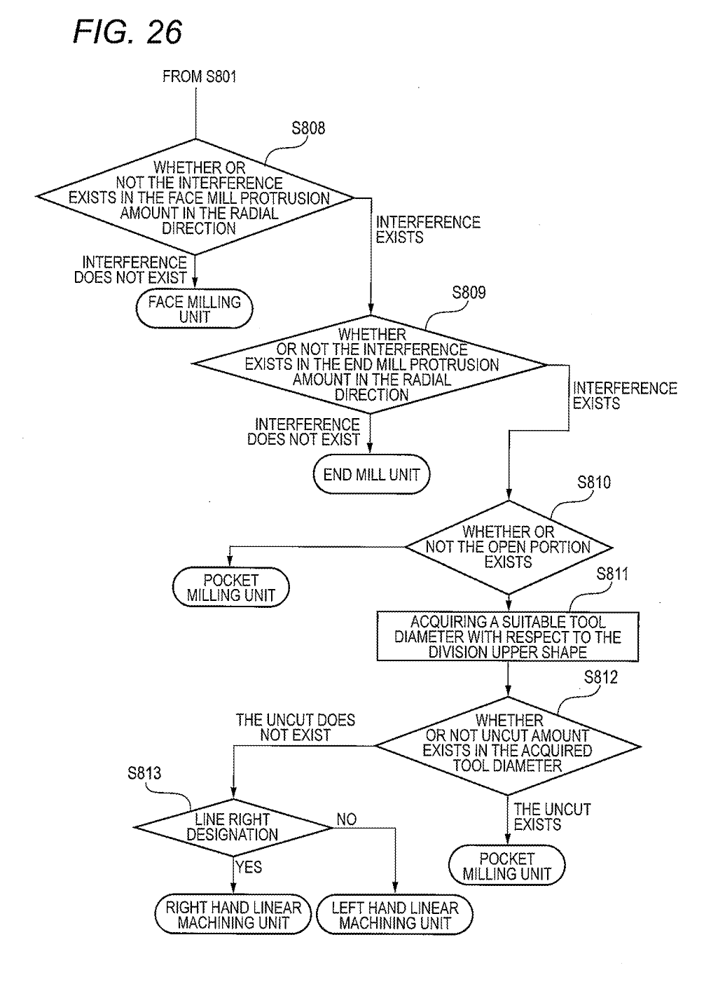

Herein, step S507 will be described in detail. FIGS. 25 and 26 are flow charts showing a line machining unit and face machining unit allocation processing of the line and face machining data creation unit 222. Hereinafter, the line machining unit and the face machining unit allocation processing of the line and face machining data creation unit 222 will be described in detail with reference to FIGS. 23 to 26.

First of all, the line machining unit will be described.

A central linear machining unit performs the machining so that the center of the tool moves on a defined shape (see FIG. 23A).

A right hand linear machining unit performs the machining so that the tool moves to the right side of the defined shape (see FIG. 23B).

A left hand linear machining unit performs the machining so that the tool moves to the left side of the defined shape (see FIG. 23C).

A outside linear machining unit performs the machining so that the tool moves around the outer side of the defined shape (see FIG. 23D).

A inside linear machining unit performs the machining so that the tool moves around the inner side of the defined shape (see FIG. 23E).

Next, the face machining unit will be described.

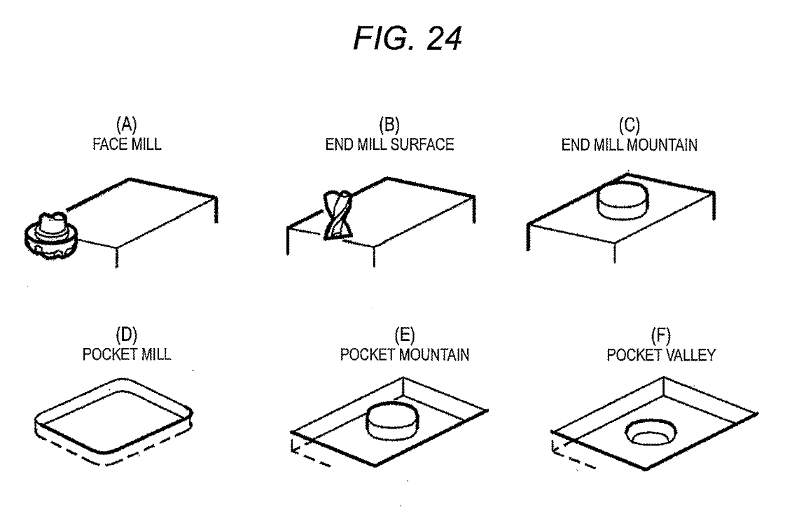

A face milling unit performs the machining of the overall outline surfaces of the defined shape by the use of a face mill. When performing the machining, the defined shape is machined to be bulged by the tool diameter (see FIG. 24A).

An end milling top unit performs the machining of the overall outline surfaces of the defined shape by the use of an end mill. When performing the machining, the defined shape is machined to be bulged by the tool radius (see FIG. 24B).

An end milling step unit performs the machining to leave the inner shape outline among the defined shape by the use of the end mill. The outer shape is set to be a pond shape and the inner shape is set to be a mountain shape. The machining is performed in a scattered manner by tool diameter with respect to the pond shape, but the tool does not protrude with respect to the mountain shape (see FIG. 24C).

A pocket milling unit performs the machining to make the defined shape a pocket by the use of the end mill (see FIG. 24D).

A pocket milling mountain unit performs the machining to make the defined shape a pocket by leaving the outline of the inner shape among the defined shapes by the use of the end mill. The outer shape is set to be the pond shape, and the inner shape is set to be the mountain shape. The tool does not protrude with respect to the pond shape and the mountain shape (see FIG. 24E).

The pocket milling valley unit performs the machining to make the defined shape a pocket by leaving the outline of the inner shape among the defined shapes by the use of the end mill. The outer shape is set to be the pond shape, and the inner shape is set to be the valley shape. The tool does not bulge with respect to the pond shape, but, with respect to the valley shape, the machining is performed to be bulged by the tool radius (see FIG. 24F).

First of all, as shown in FIG. 25, the line and plane data creation unit 222 creates a projection plane shape in which the division upper shape has been projected on the division surface from the tool direction (step S800).

The projection plane shape is evaluated by geometrically analyzing the division upper shape.

Next, it is checked whether or not the mountain and valley shape exists (step S801). Herein, a method of checking whether or not the mountain and valley shape exists is to count the number of loops of the projection plane shape, so that when the number of the loops is a plural, the mountain and valley shape is set to be present, and when the number of the loops is one, the mountain and valley shape is set to be absent. In a case where the mountain and valley shape does not exist, the process shifts to the flow chart shown in FIG. 26.

Next, in a case where the mountain and valley shape exists, during machining, it is checked whether the shape is the mountain shape which should not be bulged or the valley shape which may be bulged (step S802). Herein, the method of checking whether the shape is the mountain shape or the valley shape is to set the shape to be the mountain shape when the inner side of the loop is on the inner side of the product shape and set the shape to be the valley shape when the inner side of the loop is on the outer side of the product shape, based on the loop which is on the inner side of the projection plane shape. In step S802, when the shape is the mountain shape, the process shifts to step S805, and when the shape is the valley shape, the process shifts to step S803.

Next, when the shape is the valley shape, the line and face machining data creation unit 220 checks whether or not the removable amount of the radial direction relative to the tool direction of the division upper shape is equal to or less than the line machining radial direction maximum removable amount, and the removable amount of the axial direction is equal to or less than the line machining axial direction maximum removable amount, with reference to the line machining radial direction maximum removable amount and the line machining axial direction maximum removable amount memorized in the parameter memory portion 204 (step S803). In cases where the removable amount of the radial direction relative to the tool direction of the division upper shape is equal to or less than the line machining radial direction maximum removable amount and the removable amount of the axial direction is not equal to or less than the line machining axial direction maximum removable amount, the machining is allocated to the pocket milling valley unit. In cases where, the removable amount of the radial direction relative to the tool direction of the division upper shape is equal to or less than the line machining radial direction maximum removable amount and the removable amount of the axial direction is equal to or less than the line machining axial direction maximum removable amount, the process shifts to step S804.

The outer loop of the projected plane shape becomes the pond shape and the maximum distance between the pond shape and the valley shape is geometrically analyzed, whereby the removable amount of the radial direction relative to the tool direction of the division upper shape is evaluated. The removable amount of the axial direction becomes the size of the division upper shape relative to the tool direction. The size relative to the tool direction is evaluated by the geometric analysis. Herein, the pond shape is a shape which is defined as an outer shape outline when defining the shape to be machined, and is called a pond shape hereinafter.

Next, in cases where the removable amount of the radial direction relative to the tool direction of the division upper shape is equal to or less than the line machining radial direction maximum removable amount and the removable amount of the axial direction is equal to or less than the line machining axial direction maximum removable amount, it is checked whether or not the pond shape of the division upper shape is a full open shape which may be bulged to the outer side with respect to the tool direction (step S804). Regarding whether or not the pond shape is the full open shape, if the shape, which is offset to the outer side with respect to the tool direction with respect to the pond shape of the projection plane shape, is in the outer side of the product shape, it becomes fully open. In the case of being fully open, a central linear machining unit which sets the valley shape to be a shape sequence is allocated, and in the case where the line does not open, a inside linear machining unit which sets the pond shape to be the shape sequence is allocated.

In the case of the mountain shape in step S802, it is checked whether or not the pond shape of the outer loop of the projected plane shape is fully open (step S805). Whether or not it is the full open shape is checked in the same manner as step S804.

Next, in a case where the pond shape of the projection plane shape is not the full open in step S805, the machining is allocated to a pocket milling mountain unit which sets the projection plane shape to be the shape sequence.

In a case where the pond shape of the projection plane shape is fully open in step S805, it is checked whether or not the removable amount of the radial direction of the division upper shape is equal to or less than the line machining radial direction maximum removable amount and the removable amount of the axial direction of the division upper shape is equal to or less than the line machining radial direction maximum removable amount (step S806). In cases where the removable amount of the radial direction of the division upper shape is equal to or less than the line machining radial direction maximum removable amount and the removable amount of the axial direction of the division upper shape is equal to or less than the line machining radial direction maximum removable amount, the machining is allocated to a outside linear machining unit which sets the mountain shape of the projection plane shape to be the shape sequence.

In cases where the removable amount of the radial direction of the division upper shape is equal to or less than the line machining radial direction maximum removable amount and the removable amount of the axial direction of the division upper shape is not equal to or less than the line machining radial direction maximum removable amount in step S806, with reference to the end mill protrusion amount memorized in parameter memory portion 204, even if the length of the end mill protrusion amount in the radial direction and the pond shape of the projection plane are bulged, in the case of not interfering with the product shape, an end milling step unit which sets the shape element of the projection plane shape to be the shape sequence is set. In the case of interfering with the product shape, a pocket milling mountain unit which sets the shape element of the projection plane shape to be the shape sequence is set (step S807).

In a case where the mountain and valley shape does not exist in step S801, as shown in FIG. 26, with reference to the face mill protrusion amount memorized in parameter memory portion 204, even if the length of the face mill protrusion amount in the radial direction and the pond shape of the projection plane are bulged, in the case of not interfering with the product shape, the machining is allocated to a face milling unit which sets the projection plane to be the shape element (step S808).

Next, in the case of interfering in step S808, with reference to the end mill protrusion amount memorized in parameter memory portion 204, even if the length of the end mill protrusion amount in the radial direction and the pond shape of the projection plane shape are bulged, it is judged whether or not it interferes with the product shape (step S809). In the case of not interfering, the machining is allocated to the end mill unit which sets the projection plane shape to be the shape sequence, and in the case of interfering, the process shifts to step S810.

Next, it is checked whether or not the open portion which is machined to be bulged exists in the division upper shape (step S810). In a case where there is no open portion, the machining is allocated to the pocket milling unit which sets the projection plane shape to be the shape sequence.

Next, in a case where there is the portion which is machined to be bulged in the division upper shape in step S810, a suitable tool diameter is evaluated with respect to the division upper shape (step S811).

Herein, in acquiring the suitable tool diameter with respect to the division upper shape, among the elements which cannot be machined to be bulged in the projection plane shape, a recessed circular element is searched. In a case where the recessed circular element exists, the minimum radius or less among the recessed circular radius is selected as the tool radius. In a case where there is a recessed pin angle, the tool diameter during recessed pin angle of parameter memory portion 204 is referred to and is set to be the tool diameter. In a case where there is neither recessed circular shape nor recessed pin angle, the line machining maximum tool diameter of parameter memory portion 204 is referred to and is set to be the tool diameter.

Next, a tool sweep shape is created by the decided tool diameter with respect to the shape element which is not the open portion of the projection plane shape, and it is checked whether or not the uncut residue exists with respect to the division upper shape (step S812). The tool sweep shape is obtained by the calculation of the solid model. The obtained sweep shape is subtracted from the division upper shape, so that when the shape does not remain, the uncut residue does not exist, and when the shape remains, the uncut residue exists.

Herein, in a case where the uncut residue exists, the machining is allocated to the pocket milling unit which sets the projection plane shape to be the shape sequence. In a case where the uncut residue does not exist, a line right designation of the parameter memory portion 204 is referred to (step S813), and in the case of the line right designation, a right hand linear machining unit, which sets the shape that is not the open projection plane shape to be the shape sequence, is allocated. In a case where it is not the line right designation, a left hand linear machining unit, which sets the shape that is not the open projection plane shape to be the shape sequence, is allocated.

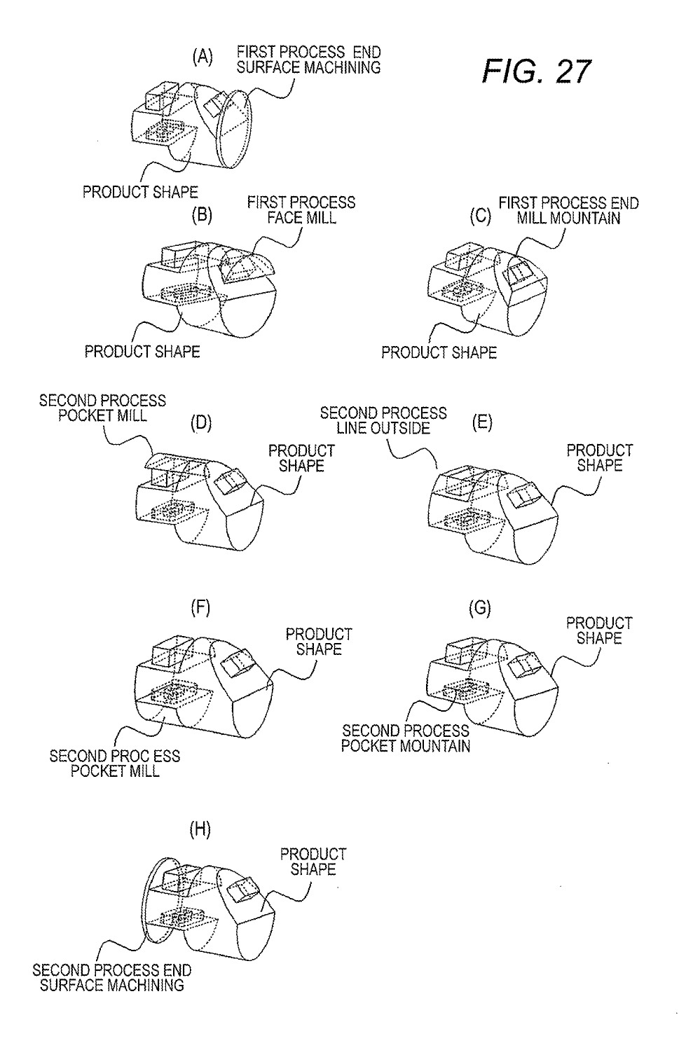

FIG. 27 is a perspective view which shows a shape machined according to the machining program created as described above. The machining program includes shape information and position information (sequence data) of a material, a machining method of a machining unit, machining condition information, tool information, machining shape information (sequence data) or the like.

That is, when the product shape shown in FIG. 6 is machined, according to the created machining program, as shown in FIGS. 27A to 27C, the end surface machining, the face mill machining, and the end mill mountain machining are carried out in the first process.

As shown in FIGS. 27D to 27H, the pocket mill machining, the line outer machining, the pocket mill machining, the pocket mountain machining, and the end surface machining are carried out in the second process.

As described above, according to the first embodiment, even if there is a plurality of machinable tool directions, a suitable tool direction with a maximum finished area and a minimum uncut residue amount of the recessed edge can be automatically set, which makes it possible to create a suitable machining program and carry out a suitable machining.

### INDUSTRIAL APPLICABILITY

The numerical control programming method and its device according to the present invention are suitable for automatically creating the numerical controlling machining program.

1. A numerical control programming method comprising:
a product shape input step of inputting a solid model of a product shape;
a product shape arrangement step of arranging the product shape;
a material shape input step of inputting a solid model of a material shape;
a material shape arrangement step of arranging the material shape;
a machining shape creation step of carrying out a differential calculation of the solid model of the material shape and the solid model of the product shape, thereby creating a solid model of a machining shape;
a step of acquiring an overall tool direction in which the face machining is possible from a face machining shape extracted from the solid model of the machining shape, thereby setting the tool direction with a maximum finished area of the product shape as the tool direction;
a step of extracting the solid model of the machining shape and the solid model of the machining shape which can be machined by the set tool direction;
a line and face machining data creation step of creating line machining data including a solid model of a line machining shape and a line machining method and face machining data including a solid model of a face machining shape and a face machining method by the solid model of the extracted machining shape; and
a program creation step of creating a machining program, in which a machining order for carrying out the line machining and the face machining is described, based on the line and face machining data.

2. (canceled)

3. The numerical control programming method according to claim 1,
wherein, when an end mill is used as a tool, an recessed edge, which is a side where the uncut residue of an inner wall angle of a recessed place is generated, is extracted, and set a tool direction with a minimum length of the extracted edge as a tool direction.

4. A numerical control programming device comprising:
a product shape input unit for inputting a solid model of a product shape;
a product shape arrangement unit for arranging the product shape;
a material shape input unit for inputting a solid model of a material shape;
a material shape arrangement unit for arranging the material shape;
a machining shape creation unit for carrying out a differential calculation of the solid model of the material shape and the solid model of the product shape, thereby creating a solid model of the machining shape;
a line and face machining data creation unit which acquires an overall tool direction in which the face machining is possible from the face machining shape extracted from the solid model of the machining shape, sets the tool direction with a maximum finished area of the product shape as the tool direction, extracts the solid model of the machining shape created by the machining shape creation unit and the solid model of the machining shape that can be machined by the set tool direction, and creates line machining data including a solid model of a line machining shape and a line machining method and face machining data including a solid model of a face machining shape and a face machining method by the solid model of the extracted machining shape; and
a program creation unit for creating a machining program, in which a machining order for carrying out the line machining and the face machining is described, based on the line and face machining data.

5. (canceled)

6. The numerical control programming device according to claim 4,
wherein, when an end mill is used as a tool, the line and face machining data creation until extracts an recessed edge which is a side where the uncut residue of an inner wall angle of a recessed place is generated, and sets a tool direction with a minimum length of the extracted edge as a tool direction.
